(19) United States
(12) Patent Application Publication
(10) Pub. No.: US 2016/0280483 A1
(43) Pub. Date: Sep. 29, 2016

(54) Robotic Document Feeder

(71) Applicant: Mentalix, Inc., Plano, TX (US)

(72) Inventors: Gary Chen, Garland, TX (US); Brian Gross, Wyomissing, PA (US); Yunsik Jung, University Park, PA (US); Meagan Kelso, Rolla, MO (US); Dale Remmers, Plano, TX (US); Jose Ruiz, Celina, TX (US); Melanie Vizcarra, Celina, TX (US); Stephen Schlarman, Allen, TX (US)

(21) Appl. No.: 15/080,045

(22) Filed: Mar. 24, 2016

Related U.S. Application Data
(60) Provisional application No. 62/138,814, filed on Mar. 26, 2015.

(51) Int. Cl. B65H 3/08; B65H 29/24; H04N 1/04; B65H 1/18; H04N 1/00; B65H 5/10; B65H 31/02

(52) U.S. Cl. CPC B65H 3/0816; B65H 5/10; B65H 29/241; B65H 31/02; B65H 1/18; H04N 1/00551; H04N 1/04; B65H 2301/4212; B65H 2301/42324; B65H 2701/1914; B65H 2801/03

(57) ABSTRACT

A system may include a robotic arm and a Bernoulli cup assembly powered by a vacuum source and coupled to the robotic arm. The Bernoulli cup assembly may lift a document, and the robotic arm may move the Bernoulli cup assembly with the lifted document to a document scanner for imaging the document. The system may further include an input bin, a scanner cover disposed over an imaging surface of the document scanner, and an output bin. A method may include lifting a document from an input bin via suction pressure using a Bernoulli cup assembly, robotically moving the Bernoulli cup assembly with the lifted document to a document scanner, and scanning the document. The method may further include robotically moving the Bernoulli cup assembly with the lifted document away from the document scanner, and de-activating the suction pressure to release the document from the Bernoulli cup assembly.

### CROSS-REFERENCE TO RELATED APPLICATIONS

This application claims the benefit of U.S. Provisional Patent Application Ser. No. 62/138,814 filed Mar. 26, 2015, and entitled “Robotic Document Feeder”, which is incorporated herein by reference in its entirety.

### BACKGROUND

Fingerprint cards are collected and stored by law enforcement and other governmental agencies for use in later identifying people by their fingerprints. Fingerprint cards have conventionally been stored in a paper format, but with the advent of scanners and computer storage, including network cloud based storage, fingerprint cards may now be imaged from a paper format for storage in an electronic format.

To ensure consistent image quality, law enforcement and governmental agencies may limit such imaging to the use of certain types of scanners, some of which may not have built-in automatic document feeder devices, and some of which may not easily or economically be retrofitted to include automatic document feeder devices. Without such automatic document feeder devices, human operators may be utilized to complete the imaging process, which is slower and more costly than using an automated solution. As such, a need exists for an economical automated solution that increases the document imaging capacity and reduces the involvement of human operators.

### SUMMARY

In accordance with the present disclosure, an implementation of a robotic document feeder system comprises a robotic arm and a Bernoulli cup assembly powered by a vacuum source and coupled to the robotic arm. When the vacuum source is activated, the Bernoulli cup assembly may create sufficient suction pressure to lift a document. The robotic arm may be configured to move the Bernoulli cup assembly with the lifted document to a document scanner for imaging the document. The system may further comprise an input bin, and the robotic arm may be configured to move the Bernoulli cup assembly over the input bin to lift the document from the input bin. In an embodiment, the input bin further comprises a moveable tray for supporting a plurality of documents within the input bin and a raising mechanism for lifting the moveable tray and the plurality of documents within the input bin. In an embodiment, the raising mechanism includes at least one motor driven pulley system coupled to the moveable tray. The system may further comprise an output bin, and the robotic arm may be configured to move the Bernoulli cup assembly with the lifted document over the output bin after the document has been scanned. The system may further comprise a scanner cover disposed over the imaging surface of the document scanner, and the scanner cover may include a designated scan area formed as a through opening in the scanner cover. In an embodiment, the scanner cover provides a support platform for the robotic arm. The system may further comprise at least one sensor for confirming the Bernoulli cup assembly lifted the document.

In accordance with the present disclosure, another implementation of the robotic document feeder system comprises a robotic arm coupled to a Bernoulli cup assembly powered by a vacuum source, an input bin for storing at least one document, a scanner cover disposed over an imaging surface of a document scanner, and an output bin. The scanner cover may include a designated scan area through which a document may be imaged by the document scanner. The scanner cover may further provide a support platform for at least one of the robotic arm, the input bin, and the output bin. In an embodiment, when the vacuum source is activated, the Bernoulli cup assembly creates sufficient suction pressure to lift a document from the input bin. In an embodiment, the robotic arm is configured to move the Bernoulli cup assembly with the lifted document from the input bin to the designated scan area for imaging the document with the document scanner. In an embodiment, the robotic arm is configured to move the Bernoulli cup assembly with the lifted document from the designated scan area to the output bin. In an embodiment, when the vacuum source is de-activated, the Bernoulli cup assembly releases the document into the output bin.

In accordance with the present disclosure, an implementation of a method comprises lifting a document from an input bin via suction pressure using a Bernoulli cup assembly, robotically moving the Bernoulli cup assembly with the lifted document to a document scanner, and scanning the document. The method may further comprise robotically moving the Bernoulli cup assembly with the lifted document away from the document scanner, and de-activating the suction pressure to release the document from the Bernoulli cup assembly. In an embodiment, the method further comprises robotically moving the Bernoulli cup assembly back to the input bin. The method may further comprise raising the document within the input bin before lifting the document via suction pressure using the Bernoulli cup assembly. In an embodiment, the method further comprises covering an imaging surface of the document scanner except for a designated scan area before robotically moving the Bernoulli cup assembly within the lifted document to the document scanner. The method may further comprise determining via a sensor whether the document was successfully lifted via suction pressure using the

Bernoulli cup assembly.

The details of one or more implementations are set forth in the accompanying drawings and the description below. Other features and advantages of the implementations will be apparent from the description and drawings.

### BRIEF DESCRIPTION OF THE DRAWINGS

FIG. 1 depicts an isometric view of an embodiment of a robotic document feeder system according to the present disclosure;

FIG. 2 depicts an isometric view of a scanner cover of the robotic document feeder system of FIG. 1 according to the present disclosure;

FIG. 3 depicts an isometric view of a Bernoulli cup assembly frame and white background of the robotic document feeder system of FIG. 1 according to the present disclosure;

FIG. 4 depicts an isometric view of a Bernoulli suction cup of the robotic document feeder system of FIG. 1 according to the present disclosure;

FIG. 5 depicts an isometric view of an input bin of the robotic document feeder system of FIG. 1 according to the present disclosure;

FIG. 6 depicts a side plan view of the input bin of FIG. 5 according to the present disclosure;

FIG. 7 depicts an isometric view of the robotic document feeder system of FIG. 1 with the Bernoulli cup assembly positioned over the top of the input bin to lift a card from the input bin according to the present disclosure;

FIG. 8 depicts an isometric view of the robotic document feeder system of FIG. 1 after the Bernoulli cup assembly has lifted a card from the input bin and the robotic arm is moving the Bernoulli cup assembly with the lifted card to a document scanner according to the present disclosure;

FIG. 9 depicts an isometric view of the robotic document feeder system of FIG. 1 with the Bernoulli cup assembly placing the lifted card into a scan area of the document scanner according to the present disclosure;

FIG. 10 depicts an isometric view of the robotic document feeder system of FIG. 1 after the Bernoulli cup assembly has lifted the card from the scan area and the robotic arm is moving the Bernoulli cup assembly with the lifted card to an output bin according to the present disclosure;

FIG. 11 depicts an isometric view of the robotic document feeder system of FIG. 1 with the Bernoulli cup assembly positioned over the top of the output bin to release the card into the output bin according to the present disclosure; and

FIGS. 12A-12B is a flow chart of an embodiment of a method for imaging fingerprint cards according to the present disclosure.

### DETAILED DESCRIPTION

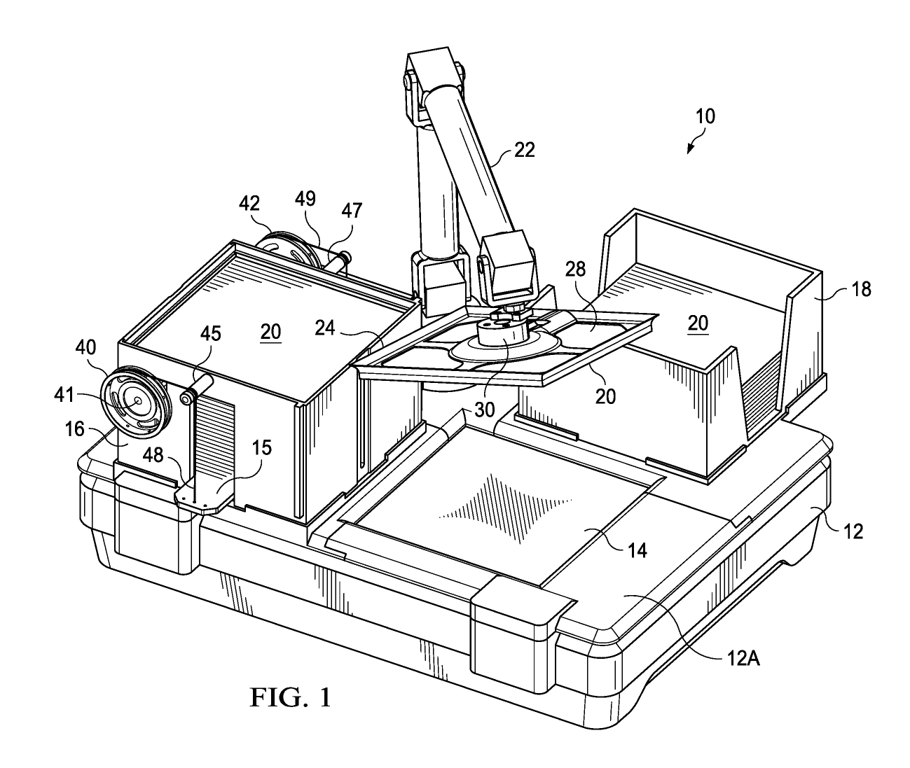

FIG. 1 depicts an isometric view of an embodiment of a robotic document feeder system (10) according to the present disclosure. The robotic document feeder system (10) comprises a robotic arm (22) coupled to a Bernoulli cup assembly (24), an input bin (16) for storing fingerprint cards (20) or other documents before imaging, a scanner cover (12A) including a through opening or scan area (14) where the fingerprint cards (20) or other documents are imaged using the scanner (12), and an output bin (18) for receiving the fingerprint cards (20) after imaging.

The robotic document feeder system (10) comprises an automated system designed to scan individual documents, such as fingerprint cards (20). As described in more detail herein, the robotic arm (22) positions the Bernoulli cup assembly (24) to pick up and secure a fingerprint card (20) from the input bin (16) via suction created by a vacuum source. In an embodiment, a photocell may be provided on the input bin (16) to ensure the card (20) has been successfully picked up. The robotic arm (22) then rotates and translates accordingly to place the Bernoulli cup assembly (24) with the lifted card (20) into the scan area (14) of the scanner cover (12A) for imaging using the scanner (12). After the scan is complete, the card (20) is picked up by the Bernoulli cup assembly (24). In an embodiment, a photocell may be provided on the robotic arm (22) to ensure the card (20) has been successfully picked up from the scanner (12). Then the robotic arm (22) rotates and translates accordingly to place the Bernoulli cup assembly (24) with the lifted card (20) over the output bin (18). Then the vacuum source is de-activated and the Bernoulli cup assembly (24) releases the lifted card (20) into the output bin (18) for retrieval and storage by the operator. Thus, the robotic document feeder system (10) uses suction to move and position each of the cards (20) for imaging rather than transporting the cards (20) through a series of rollers as in standard automatic document feeders. The disclosed system and method thereby reduces or eliminates paper jams and potential damage to the fingerprint cards (20). In an embodiment, the described process of picking up a card (20), scanning the card (20), and releasing the card into the output bin (18) takes approximately 55 to 60 seconds. In an embodiment, the robotic document feeder system (10) operates to consistently pick up a fingerprint card (20) and create an acceptable image within a +/−0.5% tolerance for error.

The robotic arm (22) may comprise a plurality of servomotors to control its base, shoulder, elbow, and wrist, respectively. In an embodiment, the robotic arm (22) is a Lynxmotion AL5D with RIOS. In an embodiment, the robotic arm (22) supports approximately 0.5 lbs. of weight in the Bernoulli cup assembly (24). A tension spring (26) may be provided between the scanner cover (12A) and the robotic arm (22) to assist the robotic arm (22) with the weight of the Bernoulli cup assembly (24) during operation.

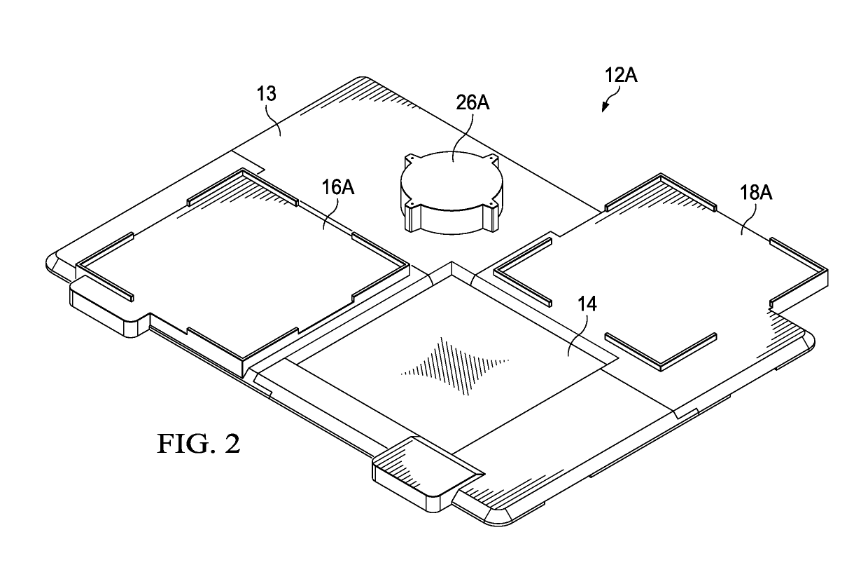

FIG. 2 depicts an isometric view of the scanner cover (12A) of the robotic document feeder system (10) of FIG. 1 according to the present disclosure. The scanner cover (12A) provides a support platform for the robotic arm (22) and other components, and the scanner cover (12A) also aids in producing consistent image size and quality by covering over substantially all areas of the imaging surface of the scanner (12) except for a designated scan area (14), which may be formed as a through opening in the scanner cover (12A). In an embodiment, the scan area (14) may be sized to correspond to that portion of the fingerprint card (20) or other document that will be imaged for electronic storage. In an embodiment, the scanner cover (12A) may optionally include one or more of an input box platform (16A), an output box platform (18A), and a raised fitting (26A) for coupling the robotic arm (22) to the scanner cover (12A). In an embodiment, the input box (16), the robotic arm (22), and the output box (18) may be positioned on the scanner cover (12A) to shorten the distance of travel for the cards (20), enable the robotic arm (22) sufficient degrees of freedom to perform smoothly, and provide the operator a robotic document feeder system (10) that can easily be transferred to multiple locations.

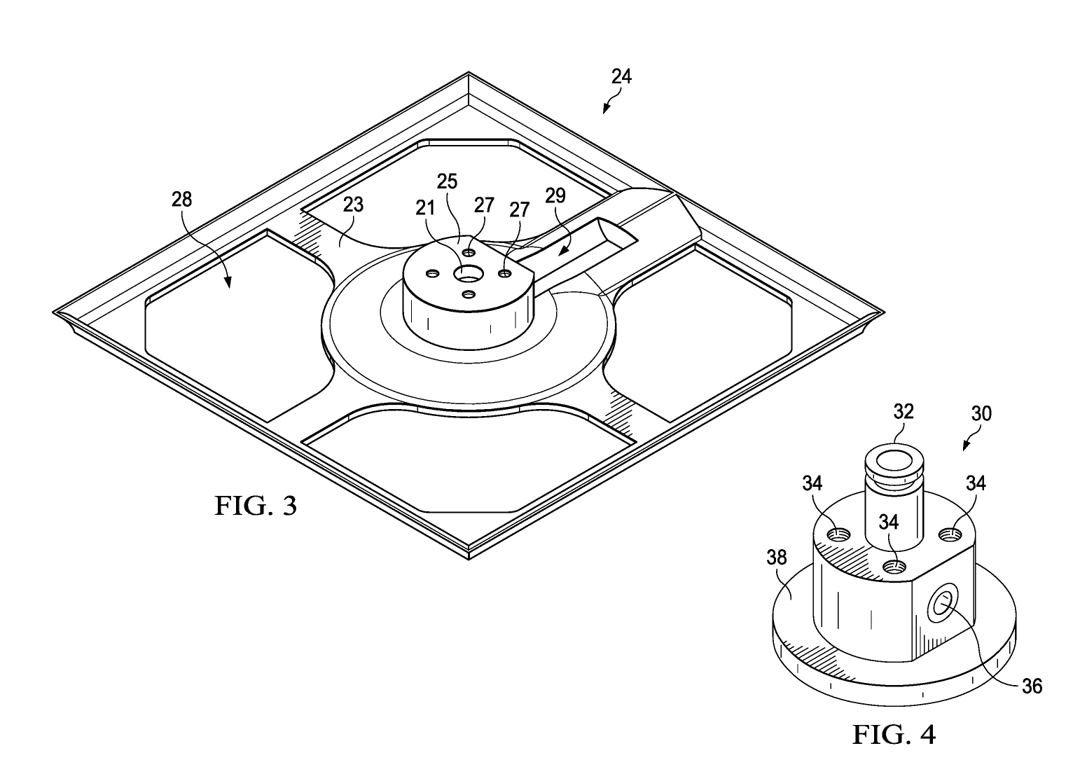

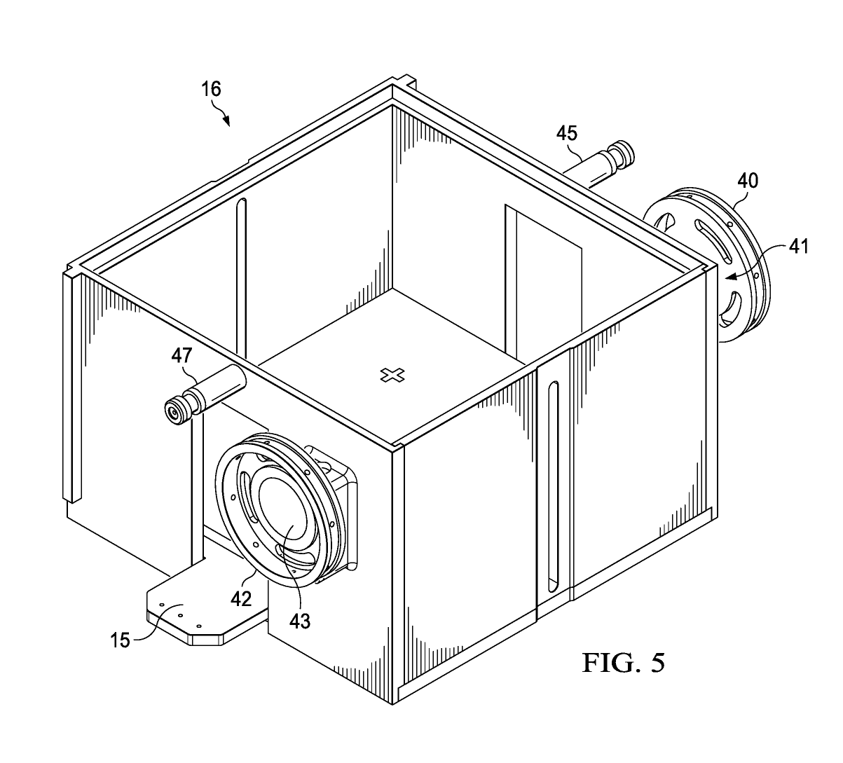

FIG. 3 and FIG. 4 depict isometric views of the components forming the Bernoulli cup assembly (24) of the robotic document feeder system of FIG. 1 according to the present disclosure. In particular, FIG. 3 depicts the frame (23) and a white background (28) of the Bernoulli cup assembly (24), and FIG. 4 depicts the Bernoulli suction cup (30) of the Bernoulli cup assembly (24).

Referring now to FIG. 3, in an embodiment, the frame (23) may comprise a generally square exterior with a generally cross-shaped interior leaving open spaces within the interior to reduce the weight of the Bernoulli cup assembly (24). To ensure scanning quality, a white background (28) may be coupled across the underside of the frame (23) to cover the open spaces within the interior of the frame (23). During scanning, the white background (28) is in contact with the back of the fingerprint card (20) and thereby covers the fingerprint card (20). This tends to enhance the quality of the image since the white background (28) limits light from leaking past the card (20) into the operating environment and producing unwanted shadows when the card (20) is scanned. The frame (23) may further comprise a generally centrally located raised component (25) with a port (21) and bolt holes (27) therein for coupling the Bernoulli suction cup (30) to the frame (23). The frame (23) may further comprise an opening (29) adjacent the raised component (25) for receiving an air line that couples between the vacuum source and the Bernoulli suction cup (30). In addition, the frame (23) may include a photo sensor to determine whether or not a card (20) was successfully retrieved.

Referring now to FIG. 4, in an embodiment, the Bernoulli suction cup (30) may comprise a base (38) with a suction area on a lower surface thereof. The Bernoulli suction cup (30) may further comprise an air chamber (36) in fluid communication with the suction area of the base (38). The air chamber (36) is operable to receive an air line from a vacuum source. The Bernoulli suction cup (30) may further comprise a generally centrally located fitting (32) that extends through the port (21) in the raised component (25) of the frame (23) and couples the Bernoulli cup assembly (24) to the robotic arm (22) as shown in FIG. 1. The Bernoulli suction cup (30) may also comprise a plurality of bolt holes (34) that align with the bolt holes (27) in the raised component (25) of the frame (23) for coupling the Bernoulli suction cup (30) to the frame (23).

The Bernoulli suction cup (30) applies the Bernoulli Principle to retrieve and release the fingerprint card (20). In an embodiment, the Bernoulli suction cup (30) is a Festo 60 mm contactless Bernoulli suction cup operable to lift a fingerprint card (20) utilizing 40 psi of suction pressure. An oil-free compressor may be used as the vacuum source. In an embodiment, the vacuum source is a California Air Compressor operable to provide at least 40 psi of suction pressure at 60 dB noise level. In an embodiment, a 12V solenoid pneumatic shut-off valve may be coupled to the vacuum source to regulate when the Bernoulli cup assembly (24) receives suction pressure.

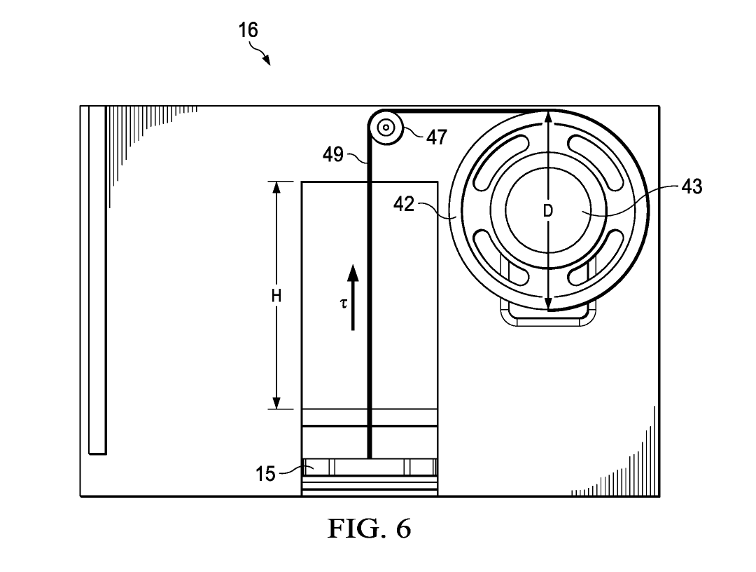

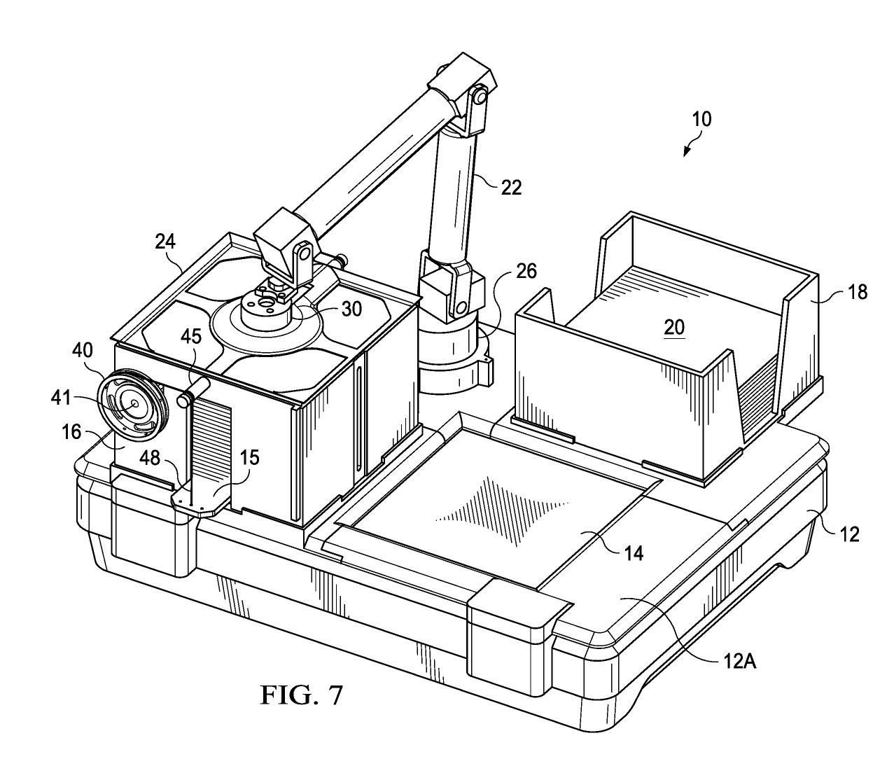

FIG. 5 depicts an isometric view, and FIG. 6 depicts a side plan view, of the input bin (16) of the robotic document feeder system (10) of FIG. 1 according to the present disclosure. The input bin (16) supports a plurality of fingerprint cards (20) therein. The input bin (16) may be designed to raise the cards (20) vertically as each card (20) is removed from the input bin (16) for scanning. The input bin (16) may include a whisker sensor for determining the level of cards (20) present within the input bin (16). The input bin (16) may further include a photocell for confirming whether or not a card (20) was retrieved from the input bin (16) during operation.

In an embodiment, the input bin (16) comprises a raising mechanism that includes a moveable tray (15) that supports the cards (20), two opposing drive pulleys (40), (42) each driven by respective servomotors (41), (43), and two opposing pulley pegs (45), (47) each supporting a respective pulley line (48), (49). As best shown in FIG. 1 and FIG. 6, the pulley lines (48), (49) are each wrapped around the respective drive pulleys (40), (42) at one end and over the pulley pegs (45), (47) to couple at an opposite end to the moveable tray (15). In operation, the servomotors (41), (43) are operated substantially simultaneously to rotate the drive pulleys (40), (42) and thereby raise the moveable tray (15) via the pulley lines (48), (49) as the pulley lines (48), (49) wrap around the drive pulleys (40), (42). In this manner, the cards (20) are incrementally raised to the top of the input bin (16) such that the robotic arm (22) and Bernoulli cup assembly (24) may be positioned at the same location over the input bin (16) each time to retrieve the next card (20).

Referring now to FIG. 6, since the two servomotors (41), (43) only allow 180 degrees of rotation, to ensure the last card (20) is raised to the top of the input bin (16), the average height (H) of the number of cards the input bin (16) can hold should be set equal to half the circumference (π×D/2) of the drive pulleys (40), (42). Then the diameter (D) of the drive pulleys can be determined using the following Equation (1):

(π×D)/2=H

D=(2×H)/π Equation (1)

To hold the weight (W) of the number of cards the input bin (16) can hold, the dynamic torque (τ_d) applied by the two servomotors (41), (43) combined must be greater than the torque created by the average weight of the cards (W) relative to the radius (D/2) of the drive pulleys (40), (42). The dynamic torque can be determined using the following Equation (2):

τ_d=D/2×W Equation (2)

As an example, if the input bin (16) is designed to hold 500 fingerprint cards (20) having an average height H=4.375 in. and an average weight W=8.75 lbs.

D=(2×H)/π

D=(2×4.375 inches)/π

D=2.785 inches Equation (1)

Thus, the diameter of each of the drive pulleys (40), (42) should be at least 2.875 inches in this example.

τ_d=D/2×W

τ_d=2.785 inches/2×8.75 lbs.

τ_d=12.184375 lbs·in.=14.038 kg·cm. Equation (2)

Thus, the dynamic torque of the two servomotors (41), (43) combined should be at least 12.184375 lbs·in. or 14.038 kg·cm. in this example.

The components making up the robotic document feeder system (10) may be formed of any suitable material. In an embodiment, the scanner cover (12A) and/or the frame (23) may be formed of plastic, and may be created using a 3D printer or a plastic mold. In an embodiment, the scanner cover (12A) and/or the frame (23) are created by a Fortus 400MC 3D printer.

In an embodiment, a SSC-32 microcontroller is used to control the servomotors (41), (43) and the sensors required to run the robotic document feeder system (10). The robotic document feeder system (10) may also include pre-programming to alert the operator when certain conditions are encountered. For example, sensors at the top of the input bin (16) may detect when the input bin (16) is empty, and pre-programming may function to alert the operator as well as stop the operation.

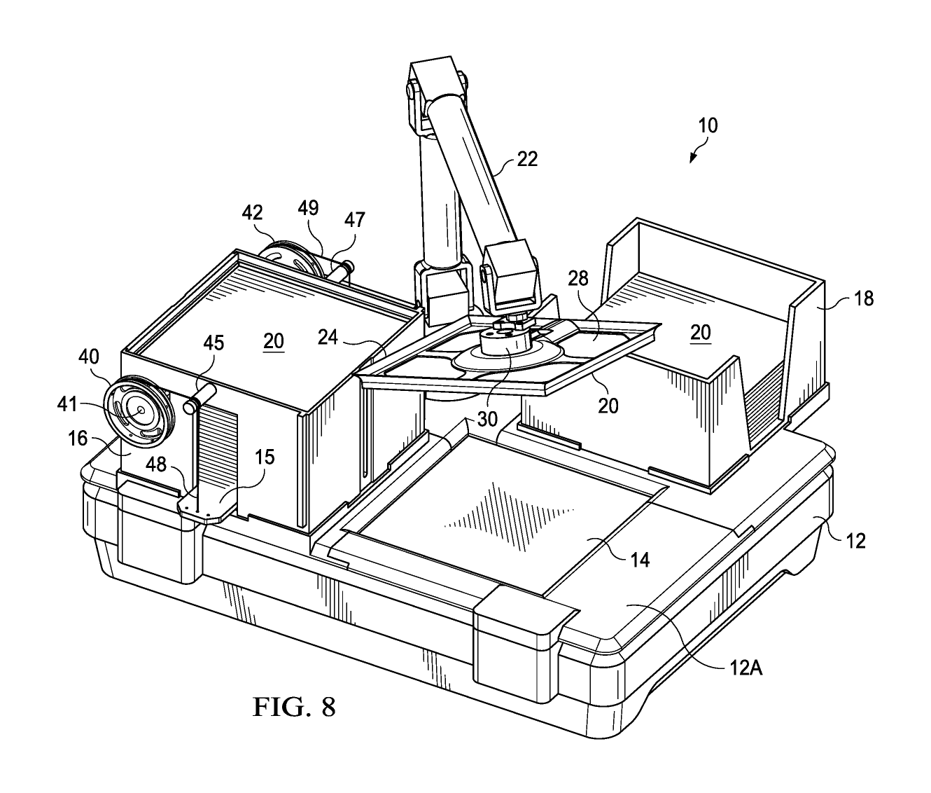

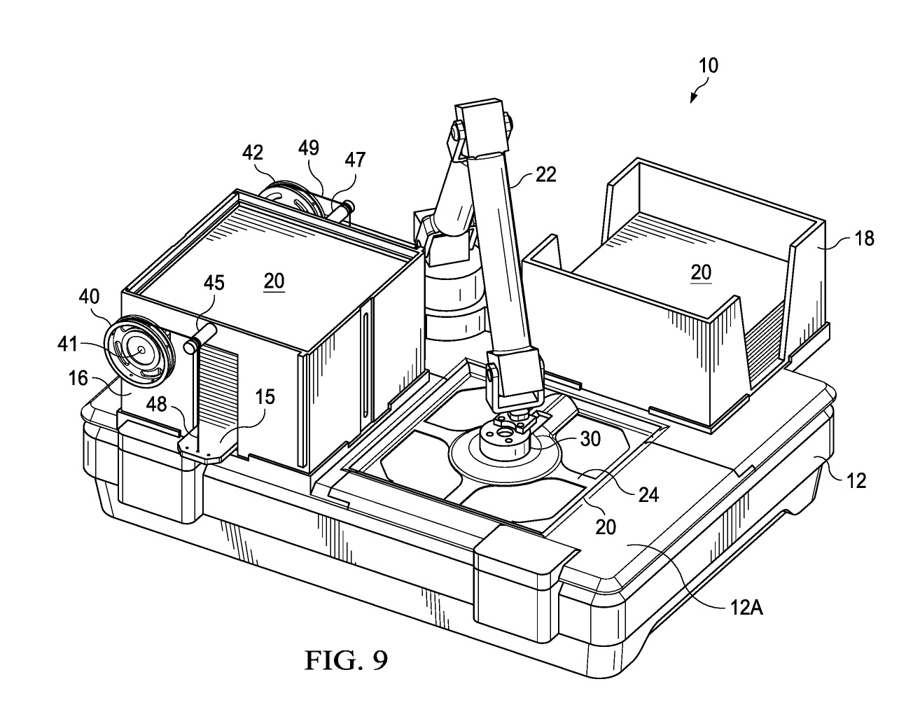

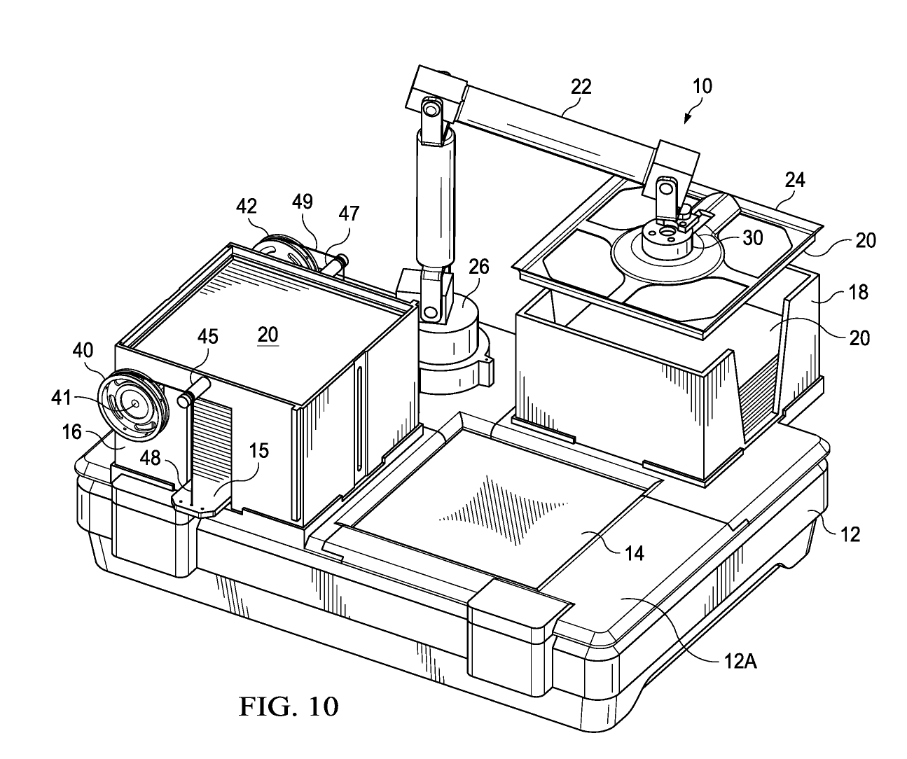

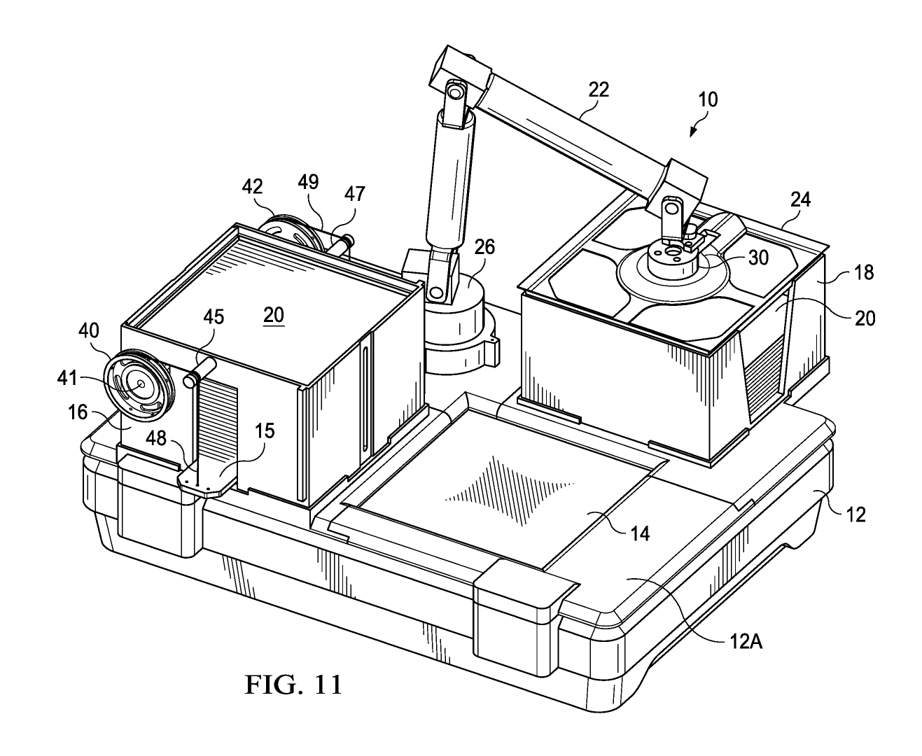

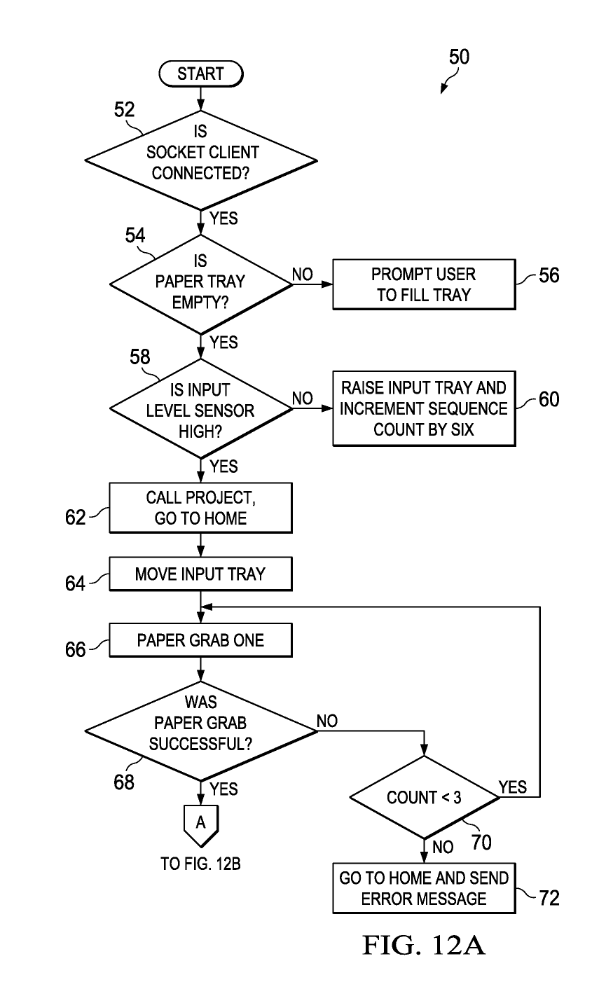

FIGS. 7-11 depict the robotic document feeder system (10) of FIG. 1 in operation to scan a fingerprint card (20) in accordance with the present disclosure. In FIG. 7, the robotic arm (22) is shown orienting the Bernoulli cup assembly (24) over the top of the input bin (16) for removing a card (20) located in the input bin (16). To lift a card (20), the solenoid valve coupled to the vacuum source is opened such that a suction pressure is created by the Bernoulli suction cup (30) and the Bernoulli cup assembly (24) retrieves the top card (20) from the input bin (16). In FIG. 8, the robotic arm (22) lifts and moves the Bernoulli cup assembly (24) with the retrieved card (20) suctioned thereto toward the scan area (14) of the scanner (12). As shown in FIG. 9, the robotic arm (22) lowers the Bernoulli cup assembly (24) such that the retrieved card (20) suctioned thereto is positioned within the scan area (14) of the scan cover (12A) for imaging by the scanner (12). Referring now to FIG. 10, after the scanner (12) images the card (20), the robotic arm (22) lifts and rotates the Bernoulli cup assembly (24) and the retrieved card (20) suctioned thereto to a position over the output bin (18). As shown in FIG. 11, robotic arm (22) then lowers the Bernoulli cup assembly (24) to position the retrieved card (20) suctioned thereto into contact with the cards (20) stored in the output bin (18). Then the solenoid valve coupled to the vacuum source is closed, thereby releasing suction pressure from the Bernoulli suction cup (30) and releasing the retrieved card into the output bin (18) where it is stored until removal by the operator.

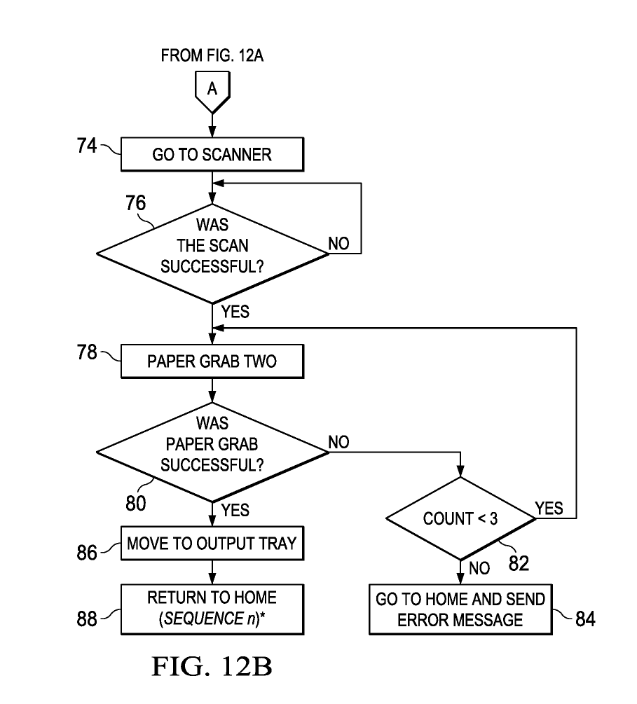

FIGS. 12A-12B depict a flowchart of a method (50) for scanning a fingerprint card (20) or other document using the robotic document feeder system (10) of FIG. 1 in accordance with the present disclosure. Referring now to FIG. 12A, at Step (52), the connection of the socket client is determined. If the socket client is connected at Step (52), then at Step (54) the condition of the paper tray or input bin (16) is determined. If the paper tray or input bin (16) is empty at Step (54), then at Step (56) the user is prompted to fill the tray or input bin (16). Once the paper tray or input bin (16) has been filled, then at Step (58) a position of the input level sensor is noted. If the input level sensor is not high at Step (58), then at Step (60) the tray (15) on the input bin (16) is raised, and the sequence count is incremented by six. If the input level sensor is high at Step (58), then at Step (62), the robotic document feeder system (10) is ready for actuation and returns to the home position. At Step (64), the input bin (16) is moved into position and at Step (66) one card (20) is grabbed from the input bin (16). At Step (68), a determination is made whether the paper grab was successful. If the paper grab was not successful at Step (68), at Step (70) a determination is made whether there have been less than 3 unsuccessful paper grabs. If there have been less than 3 unsuccessful paper grabs at Step (70), the method returns to Step (66) where the paper grab is attempted again, otherwise, at Step (72), the system (10) is returned to home and an error message is sent.

Referring now to FIG. 12B, if the paper grab was successful at Step (68), then at Step (74) the card (20) is moved to the scanner and a scan is made. At Step (76), a determination is made whether the scan was successful. If the scan was not successful at Step (76), the method returns to Step (74) to make another scan. If the scan was successful at Step (76), then at Step (78) the card (20) is grabbed from the scanner (12). At Step (80), a determination is made whether the paper grab was successful. If the paper grab was not successful at Step (80), at Step (82) a determination is made whether there have been less than 3 unsuccessful paper grabs. If there have been less than 3 unsuccessful paper grabs at Step (82), the method returns to Step (78) where the paper grab is attempted again, otherwise, at Step (84), the system (10) is returned to home and an error message is sent. If the paper grab was successful at Step (80), then at Step (86) the card (20) is moved to the output tray (18). Then at Step (88), the system (10) is returned to the “home” position to continue imaging operations for the remaining cards (20) in the input bin (16) until the input bin (16) is empty or until scanning operations are suspended by the operator.

Illustrative embodiments have been described herein and it will be apparent to those skilled in the art that the systems and methods disclosed herein may incorporate changes and modifications without departing from the general scope of the disclosure. It is intended to include all such changes and modifications within the scope of the present disclosure.

1. A system comprising:
a robotic arm; and
a Bernoulli cup assembly powered by a vacuum source and coupled to the robotic arm;
wherein when the vacuum source is activated, the Bernoulli cup assembly creates sufficient suction pressure to lift a document; and
wherein the robotic arm is configured to move the Bernoulli cup assembly with the lifted document to a document scanner for imaging the document.

2. The system of claim 1, further comprising:
an input bin;
wherein the robotic arm is configured to move the Bernoulli cup assembly over the input bin to lift the document from the input bin.

3. The system of claim 2, wherein the input bin further comprises:
a moveable tray for supporting a plurality of documents within the input bin; and
a raising mechanism for lifting the moveable tray and the plurality of documents within the input bin.

4. The system of claim 3, wherein the raising mechanism further comprises:
at least one motor driven pulley system coupled to the moveable tray.

5. The system of claim 1, further comprising:
an output bin;
wherein the robotic arm is configured to move the Bernoulli cup assembly with the lifted document over the output bin after the document has been scanned.

6. The system of claim 1, further comprising:
a scanner cover disposed over the imaging surface of the document scanner;
wherein the scanner cover comprises a designated scan area formed as a through opening in the scanner cover.

7. The system of claim 6:
wherein the scanner cover provides a support platform for the robotic arm.

8. The system of claim 1, further comprising:
at least one sensor for confirming the Bernoulli cup assembly lifted the document.

9. A system comprising:
a robotic arm coupled to a Bernoulli cup assembly powered by a vacuum source;
an input bin for storing at least one document;
a scanner cover disposed over an imaging surface of a document scanner; and
an output bin;
wherein the scanner cover comprises a designated scan area through which a document may be imaged by the document scanner.

10. The system of claim 9:
wherein when the vacuum source is activated, the Bernoulli cup assembly creates sufficient suction pressure to lift a document from the input bin.

11. The system of claim 10:
wherein the robotic arm is configured to move the Bernoulli cup assembly with the lifted document from the input bin to the designated scan area for imaging the document with the document scanner.

12. The system of claim 11:
wherein the robotic arm is configured to move the Bernoulli cup assembly with the lifted document from the designated scan area to the output bin.

13. The system of claim 12:
wherein when the vacuum source is de-activated, the Bernoulli cup assembly releases the document into the output bin.

14. The system of claim 9:
wherein the scanner cover provides a support platform for at least one of the robotic arm, the input bin, and the output bin.

15. A method comprising:
lifting a document from an input bin via suction pressure using a Bernoulli cup assembly;
robotically moving the Bernoulli cup assembly with the lifted document to a document scanner; and
scanning the document.

16. The method of claim 15, further comprising:
robotically moving the Bernoulli cup assembly with the lifted document away from the document scanner; and
de-activating the suction pressure to release the document from the Bernoulli cup assembly.

17. The method of claim 16, further comprising:
robotically moving the Bernoulli cup assembly back to the input bin.

18. The method of claim 15, further comprising:
raising the document within the input bin before lifting the document via suction pressure using the Bernoulli cup assembly.

19. The method of claim 15, further comprising:
covering an imaging surface of the document scanner except for a designated scan area before robotically moving the Bernoulli cup assembly within the lifted document to the document scanner.

20. The method of claim 15, further comprising:
determining via a sensor whether the document was successfully lifted via suction pressure using the Bernoulli cup assembly.
